(19) United States
(12) Patent Application Publication
(10) Pub. No.: US 2011/0269856 A1
(43) Pub. Date: Nov. 3, 2011

(54) CAPTURING MATERIAL, PRODUCING PROCESS THEREOF, AND SOLID-PHASE EXTRACTION CARTRIDGE

(75) Inventors: Kyoichi SAITO, Tokyo (JP); Shinsuke Yamada, Kasugai-shi (JP); Kazuyoshi Miyoshi, Ichihara-shi (JP)

(73) Assignee: INOAC CORPORATION, Aichi (JP)

(21) Appl. No.: 13/182,126

(22) Filed: Jul. 13, 2011

Related U.S. Application Data
(62) Division of application No. 12/128,115, filed on May 28, 2008.

(51) Int. Cl. C08J 9/224

(52) U.S. Cl. 521/54

(57) ABSTRACT

Disclosed is a capturing material including a substrate containing a porous body having continuous pores, wherein the substrate has a bilayer structure including: a surface region to which a graft polymer chain to which a capturing functional group for capturing an object to be captured is incorporated is bonded; and an inner region to which the graft polymer chain is not bonded.

### RELATED APPLICATIONS

The present application is a divisional of U.S. patent application Ser. No. 12/128,115, filed May 28, 2008, which is expressly incorporated herein by reference in its entirety.

### BACKGROUND OF THE INVENTION

1. Field of the Invention

The present invention relates to a capturing material used to capture, for example, a metal ion, a protein or some other component, a producing process thereof, and a solid-phase extraction cartridge (=cartridge for solid phase extraction).

2. Description of Related Art

In order to measure quantitatively a metal ion, an organic material, a protein or some other molecule that is contained in an environment sample, it is necessary to conduct separation and purification of the ion or molecule as a pre-treatment of the measurement. So far, the separation and purification have been conducted by, for example, a solvent extraction method using an extracting reagent (for example, Hideo Akaiwa “Extracting and Separating Analysis” (4^{th} edition), Kodansha Ltd., published in 1976 (pp. 110-115)) and an ion exchange method using an ion exchange resin (for example, Mitsubishi Chemical Corp., Ion Exchange Resin Division, “Ion Exchange Resin/Synthetic Absorbent Manual, Application Version” (4^{th} edition), manufactured by Mitsubishi Chemical Corp., published in 1995 (pp. 11-25)). However, the solvent extraction method in the prior art has a problem that a large amount of harmful organic waste fluid is generated, and the ion exchange method has a problem that the method is low in selectivity of a specific metal ion.

Incidentally, the material obtained by introducing a functional group capable of capturing an ion or molecule (=ionic or molecular species) into a solid through a covalent bond or causing an extracting reagent to be carried onto a solid by use of hydrophobic interaction is called solid-phase extraction (SPE) material. When a great volume of a sample liquid containing an ion or molecule, which is an object to be measured, is brought into contact with this solid-phase extraction material, the solid-phase extraction material can certainly capture the ion or molecule. Thereafter, a small amount of an acid or salt solution is used to elute out the whole quantity of the captured ion or molecule. By this operation, the separation and purification of the ion or molecule are attained.

Solid-phase extraction material is a bead-form material made of a polymer or inorganic compound. The material is used in the state that the beads are filled into a cylindrical cartridge. Moreover, the following solid-phase extraction cartridge is commercially available: an extraction cartridge wherein beads are incorporated into fibers and the fibers are turned to the form of sheets so as to be filled into a cylindrical cartridge in order to cause a sample liquid to flow into the cartridge at a high speed. As the diameter of the beads becomes larger, the sample liquid is caused to flow more easily but it takes more time for an ions or a molecule to shift to the functional group or extracting reagent in the beads. In other words, such a technique has a drawback that a reduction in the resistance against the flow of the sample liquid is not compatible with an increase in the capturing efficiency of the ion or molecule.

As such a solid-phase extraction material, known is a selectively adsorbing porous membrane wherein a side chain (side chain species) having a predetermined functional group is chemically bonded to the membrane pore surface of a porous substrate membrane which is made of, for example, polyolefin and has a three-dimensional network structure (see, for example, Japanese Patent Application Laid-Open (JP-A) No. 08-141392 (pp. 2 and 3, and FIG. 1). This selectively adsorbing porous membrane is produced by radiating an ionizing radiation ray onto a porous substrate membrane, graft-polymerizing a vinyl monomer having an epoxy group onto the membrane, and then causing an alcohol or the like to react with the monomer on the membrane under an alkaline condition.

The selectively adsorbing porous membrane described in JP-A No. 08-141392 makes it possible to specify the content of a hydroxyl group as a functional group and further make the hydrophobicity of the membrane high, thereby adsorbing (capturing) a protein promptly. However, the porous substrate membrane described in JP-A No. 08-141392 is thin; therefore, when graft polymerization is conducted to bond side chains to the porous substrate membrane, a graft polymer is produced over the whole of the porous substrate membrane along the thickness direction thereof. When the graft polymer is produced inside the porous substrate membrane, the texture or tissue in the polymer-produced regions is interrupted so that the denseness of the regions becomes insufficient. Thus, the rigidity of the porous substrate membrane lowers. As a result, about the resultant selectively adsorbing porous membrane, the swelling degree thereof based on a solvent becomes large and further the strength thereof cannot be kept.

### SUMMARY OF THE INVENTION

Thus, an object of the present invention is to provide a capturing material which has a high efficiency of capturing an object to be captured so as to attain a high-speed treatment, and which has a small swelling degree and can keep a sufficient strength; a producing process; and a solid-phase extraction cartridge.

So far, the inventors have produced various functional materials by bonding a graft polymer chain to polymeric material substrates in the form of a film, a hollow-fiber membrane, a nonwoven cloth and so on, and then introducing, into the resultant substrates, a functional group corresponding to usage. The structures of commercially available solid-phase extraction cartridges have been researched and further a solution of drawbacks in operation of the cartridges has been investigated. The inventors have then hit on a matter that a graft polymer chain is given to a continuously-porous body having an appropriate thickness as a substrate.

The inventors have repeatedly made eager researches to find out that a function group or extracting reagent for capturing a metal ion or a molecule, such as a protein, is introduced to a graft polymer chain bonded to a sheet-form continuously-porous body, or is caused to be carried to the same graft polymer chain, and further the resultant is used to produce a solid-phase extraction cartridge, whereby the ion or the molecule can be effectively separated and purified. Thus, the present invention has been made.

According to a first aspect of the invention, a capturing material, comprises a substrate comprising a porous body having continuous pores, wherein the substrate has a bilayer structure comprising: a surface region to which a graft polymer chain to which a capturing functional group for capturing an object to be captured is incorporated is bonded; and an inner region to which the graft polymer chain is not bonded.

Preferably, the substrate comprising a porous body is a sheet-form substrate having a thickness of 1 to 10 mm wherein the average pore diameter of the continuous pores is from 0.5 to 5 μm and the volume fraction of the continuous pores is from 70 to 85%.

Preferably, the capturing functional group is a group wherein at least one of an epoxy group is substituted with a chelate-forming group or an ion-exchange group.

Preferably, the graft polymer chain is bonded to the surface of the continuous pores in the porous body.

Preferably, the substrate is made of a polyolefin porous body having continuous pores.

According to a second aspect of the invention, a producing method of a capturing material, comprises the steps of: radiating a surface region of a substrate comprising a porous body having continuous pores with ionizing radiation ray; graft-polymerizing a polymerizable monomer having a functional group on the surface region of the substrate; and converting at least one of the functional group to a capturing functional group.

A third aspect of the invention is a solid-phase extraction cartridge, wherein the capturing material of the first aspect is filled into a cartridge.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic view which schematically illustrates a producing process of the capturing material of the present invention;

FIG. 2 is a graph showing a relationship between reaction time and conversion ratio in reaction for introducing an iminodiacetate group to an epoxy group in a graft polymer chain bonded to a surface region of a substrate made of a polyethylene foamed body;

FIG. 3 is a schematic view illustrating an apparatus for causing an object to be captured to flow into a cylindrical cartridge into which a capturing material is filled, so as to cause the capturing material to capture the object;

FIG. 4 is a graph showing breakthrough curves obtained by causing a copper ion solution to flow into a cylindrical cartridge into which a capturing material having an iminodiacetate group is filled;

FIG. 5 is a graph showing a relationship between reaction time and conversion ratio in reaction for introducing a sulfonate group to an epoxy group in a graft polymer chain bonded to a surface region of a substrate made of a polyethylene foamed body; and

FIG. 6 is a graph showing breakthrough curves obtained by causing a lysozyme solution to flow into a cylindrical cartridge into which a capturing material having a sulfonate group is filled.

### DETAILED DESCRIPTION OF THE PREFERRED EMBODIMENTS

With reference to the attached drawings, an embodiment of the invention will be described in detail hereinafter.

The capturing material of the embodiment is a capturing material comprising a substrate made of a porous body having continuous pores wherein the substrate has a bilayer structure composed of a surface region to which a graft polymer chain to which a capturing functional group for capturing an object to be captured is incorporated is bonded, and an inner region to which the graft polymer chain is not bonded. In short, the capturing material has a bilayer structure of a surface region having a graft polymer chain and an inner region having no graft polymer chain. In the surface region, the capturing functional group of the graft polymer chain exhibits a function of capturing an object to be captured. In the inner region, its dense structure is maintained without the substrate being denatured, so that the region exhibits a physical (mechanical) function of the capturing material. Since the graft polymer chain has a non-crosslinked polymer structure, a functional group is easily introduced, at a high density, to the chain or an extracting reagent is caused to be easily carried, at a high density, onto the chain.

It is preferred that the substrate, which is made of a porous body, is a sheet-form substrate having a thickness of 1 to 10 mm wherein the average pore diameter of continuous pores is from 0.5 to 5 μm and the volume fraction of the continuous pores is from 70 to 85%. If the thickness of the substrate is less than 1 mm, the thickness is too small so that the capturing material is not easily formed to have the above-mentioned bilayer structure. On the other hand, if the thickness is more than 10 mm, it is difficult that, for example, when the capturing material is filled into a cartridge to constitute a solid-phase extraction cartridge, the capturing material is filled into the cartridge or is handled for some other purpose.

If the average pore diameter of the continuous pores is less than 0.5 μm, the continuous pores become too fine so that the capturing function tends not to be sufficiently fulfilled the interior of the continuous pores. On the other hand, if the average pore diameter of the continuous pores is more than 5 μm, the number of the continuous pores in the substrate surface is reduced so that the capturing function declines. If the volume fraction of the continuous pores is less than 70%, the ratio by volume of the continuous pores becomes small so that the capturing efficiency tends to lower. On the other hand, if the volume fraction is more than 85%, the continuous pores become excessive in volume so that the strength of the capturing material falls. The graft polymer chain (species) is preferably bonded to the surface region of the continuous pores in order to use the fine pores, the number of which is very large, present in the surface region of the porous body to make the capturing efficiency high.

The above-mentioned capturing functional group is a functional group for capturing an object to be captured, such as a metal ion, or a protein by chelate (coordinate) bonding, ion bonding or the like. The capturing functional group may be a chelate-forming group, an ion-exchange group (cation-exchange group or anion-exchange group), a hydrophobic group, a hydrophilic group, or any combination of two or more of these groups. Examples of the chelate-forming group include an iminodiacetate group, and an iminodiethanol group. Examples of the cation-exchange group include a sulfonate group (sulfonic acid group), a phosphate group (phosphoric acid group), and a carboxylic group. Examples of the anion-exchange group include a primary amino group, a secondary amino group, a tertiary amino group, a quaternary amino group, and a quaternary ammonium salt group. Examples of the hydrophobic group include an alkyl group, an alkylamino group, an epoxy group, and a phenyl group. An example of the hydrophilic group is a diol group. The capturing functional group is introduced, for example, by substituting at least one partial quantity of the epoxy group species bonded to the side chain of the graft polymer (i.e., at least one part of the epoxy groups bonded to the side chains of the graft polymer) with the capturing functional group (i.e., the capturing functional groups), such as the chelate-forming group or the ion-exchange group (for example, cation-exchange group).

Moreover, the functional group suitable for carrying an extracting reagent for extracting an object to be captured can be introduced to the substrate. Examples of a combination of the extracting reagent with the capturing functional group having a function of carrying the reagent include a combination of bis(2-ethylhexyl)phosphate with an octadecylamino group, that of bis(2-ethylhexyl)phosphate with a dodecylamino group, that of bis(2,4,4-trimethylpentyl)phosphonic acid with an octadecylamino group, and that of bis(2,4,4-trimethylpentyl)phosphonic acid with a dodecylamino group.

The above-mentioned substrate is preferably made of a polyolefin porous body in order to lower the reactivity of the substrate itself and cause selective capturing through the capturing functional group of the graft polymer chain. Examples of the polyolefin include polyethylene and polypropylene. Other examples of the material which constitutes the porous body include fluorine-contained resins such as polytetrafluoroethylene (PTFE), and any combination (mixture or copolymer) of two or more of these resins.

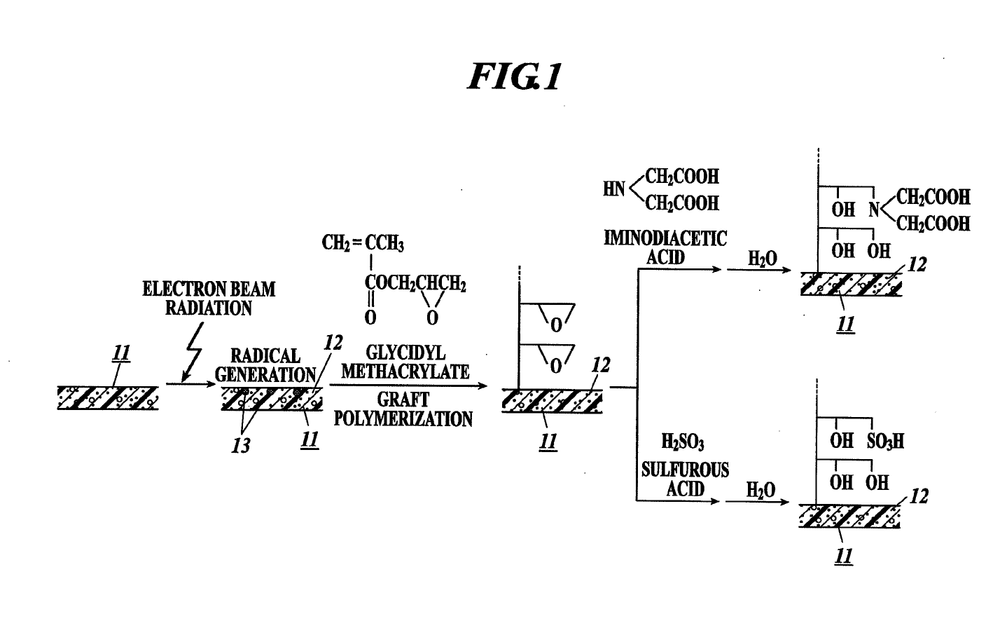

A producing process of the capturing material is a process including the steps of: radiating an ionizing radiation ray to a surface region of a substrate comprising a porous body having continuous pores; graft-polymerizing a polymerizable monomer having a functional group on the surface region of the substrate; and converting at least one partial quantity of the functional group to a capturing functional group. This producing process will be described hereinafter with reference to FIG. 1, which illustrates the process schematically.

As illustrated in FIG. 1, an electron beam as an ionizing radiation ray is radiated to a surface region 12 of a substrate 11, thereby generating radicals 13 in the surface region 12 of the substrate 11. In this state, for example, glycidyl methacrylate as a polymerizable monomer having an epoxy group is caused to act thereon to conduct graft polymerization on the surface region 12 of the substrate 11. According to such graft polymerization, side chains of the graft polymer extend from the surface region 12 of the substrate 11. Plural epoxy groups are bonded to the side chains.

As the polymerizable monomer, various polymerizable monomers may be used in accordance with a capturing functional group to be introduced. Examples of the polymerizable monomer include a polymerizable monomer having an epoxy group, a polymerizable monomer having a hydrophilic group, and a polymerizable monomer having a hydrophobic group. Particularly useful examples of the epoxy-group-having polymerizable monomer include glycidyl methacrylate (GMA), and glycidyl acrylate. Examples of the hydrophilic-group-having polymerizable monomer include 2-hydroxyethyl methacrylate, vinylpyrrolidone, dimethylacrylamide, and ethylene glycol dimethacrylate. Examples of the hydrophobic-group-having polymerizable monomer include alkyl methacrylate and alkyl acrylate. These polymerizable monomers may be used alone or in the form of a mixture wherein two or more thereof are mixed at an arbitrary ratio.

The method for the graft polymerization of the polymerizable monomer may be, for example, a polymerization method using a polymerization initiator besides the polymerization method using an ionizing radiation ray. In the method using a polymerization initiator, only the surface region of the substrate is impregnated with the initiator. According to any one of the graft polymerization methods, a graft macromer (graft polymer) having a target polymerization degree can be obtained by controlling conditions for the polymerization appropriately. In the case of using an ionizing radiation ray, the ray may be an ultraviolet ray, an electron beam, an X-ray, an α-ray, a β-ray, a γ-ray, or the like.

When the grafting ratio (the ratio of an increase in graft polymer chains) in graft polymerization is defined as the increase ratio of the mass of the substrate after the graft polymerization to that of the substrate before the graft polymerization, the grafting ratio is preferably from about 100 to 200%. If the grafting ratio is less than 100% or less, the grafting ratio is low so that the ratio (i.e., the content by percentage) of a capturing functional group generated in the substrate also unfavorably becomes small. On the other hand, if the grafting ratio is more than 200%, the graft polymer tends to be bonded unfavorably to the whole of the capturing material.

Thereafter, in order to convert a partial quantity of the epoxy group species (i.e., a part of the epoxy groups) to, for example, an iminodiacetate group as the capturing functional group, iminodiacetic acid is caused to act on the graft polymer in the presence of water, thereby ring-opening the epoxy group so as to be converted to the iminodiacetate group. By the iminodiacetate group, a metal ion such as a copper ion is chelated so as to be captured. In order to convert a partial quantity of the epoxy group species to, for example, a sulfonate group as the capturing functional group, sulfurous acid is caused to act on the graft polymer in the presence of water, thereby ring-opening the epoxy group so as to be converted to the sulfonate group. By the sulfonate group, a protein or the like is subjected to ion (cation) exchange, so as to be captured. By such an operation, a target capturing material is produced.

The substitution ratio (conversion ratio) from the functional group (for example, an epoxy group) in the graft polymer chain to the capturing functional group (for example, an iminodiacetate group) is set into the range of, for example, 5 to 90%. If the conversion ratio is less than 5%, the content by percentage of the capturing functional group in the substrate is small so that an object to be captured cannot be sufficiently captured. On the other hand, if the conversion ratio is more than 90%, reaction conditions for the conversion unfavorably become severe.

When the object captured by the capturing material is released, hydrochloric acid is used in the case of a copper ion captured by the iminodiacetate group and sodium chloride is used in the case of a protein molecule captured by the sulfonate group.

As described above, the capturing material has a bilayer structure composed of a surface region having a graft polymer chain and an inner region having no graft polymer chain. About the ratio of the graft-polymer-chain-having surface region in the capturing material (when the surface region is present in each of both surfaces of the substrate, the ratio of the total of the regions), it is preferred that the thickness of the surface region(s) is from 40 to 60% of the thickness of the capturing material, that is, the thickness of the inner region, which has no graft polymer chain, is from 60 to 40% thereof. When the ratio is set into this range, the balance between the capturing efficiency of capturing an object to be captured and the following can be kept good: the swelling degree and the strength (one example thereof is the deformation resistance). In order to set the ratio between the surface region(s) and the inner region of the capturing material into this range, conditions for the graft polymerization are appropriately controlled, examples of the conditions including the concentration of the polymerizable monomer, the kind of the solvent to be used, the reaction temperature, and the reaction time. In the case of using, for example, a polyethylene foamed body as the porous body, which constitutes the substrate, the ratio of the surface region(s) having the graft polymer chain can be made small by using a solvent wherein polyethylene is not easily dissolved, or making the reaction time short.

By use of the capturing material obtained as described above, various functional materials can be provided. About any one of the functional materials, the form thereof can be appropriately changed in accordance with the use purpose thereof or the use manner thereof. Examples thereof include a solid-phase extraction cartridge and a solid-phase extraction kit. The solid-phase extraction cartridge is formed by filling the capturing material into a cartridge. This cartridge is easily formed, and makes it possible to separate and purify an ion or molecule at a high efficiency from various liquids.

The effect of the present embodiment will be described hereinafter. When the capturing material is produced, an electron beam is radiated to a surface region of a substrate made of a polyethylene foamed body having continuous pores, thereby generating radicals. Thereafter, glycidyl methacrylate is graft-polymerized in the surface region of the substrate. Iminodiacetic acid is caused to act on the resultant graft polymer to convert a partial quantity of the epoxy group to an iminodiacetate group.

In the resultant capturing material, a graft polymer chain having the iminodiacetate group for capturing a copper ion as an object to be captured is bonded to the continuous-pore-containing surface region of the substrate. For this reason, the iminodiacetate group of the graft polymer chain extending from the surface region of the substrate into the continuous pores can easily capture a copper ion contacting the iminodiacetate group by chelating effect.

On the other hand, the inner region of the substrate is in the state that the graft polymer chain is not bonded to the region; thus, the inner region of the substrate has a dense structure. Accordingly, when the capturing material is used, the material is not easily swelled or shrunken by effect of a solvent and further the strength can be kept so as to be restrained from being deformed.

Advantageous effects produced by the present embodiment will be collectively described hereinafter.

In the capturing material of the embodiment, a graft polymer chain to which a capturing functional group for capturing an object to be captured is introduced is bonded to a surface region of a substrate; therefore, the material has a high capturing efficiency of capturing the object to be captured so as to make a high-speed treatment possible. An inner region of the substrate is in the state that the graft polymer chain is not bonded to the region so that the inner region of the substrate has a dense structure. Thus, the capturing material has a small swelling degree based on a solvent and further can keep the strength thereof.

The substrate contains a great number of fine continuous pores, and the average pore diameter of the continuous pores in the substrate is from 0.5 to 5 μm and the volume fraction of the continuous pores is from 70 to 85%, whereby the capturing function group of the graft polymer chain positioned in the surface region of the substrate, which contains the fine continuous pores, can exhibit the function thereof sufficiently. Furthermore, the substrate is a sheet-form substrate having a thickness of 1 to 10 mm, and is formed to have a larger thickness than conventional selectively adsorbing porous membranes or analogues thereof, thereby making it possible to form easily a structure wherein a graft polymer chain is bonded to the surface region of the substrate and the graft polymer chain is not bonded to the inner region of the substrate.

When the capturing functional group is a group (species) wherein at least one partial quantity of an epoxy group (species) is substituted with a chelate-forming group or ion-exchange group (species), a metal ion can be chelated so as to be captured or a protein can be caused to undergo ion exchange so as to be captured.

When the graft polymer chain is bonded to the surface region of the continuous pores, the number of which is very large, in the porous body, the capturing functional group of the graft polymer chain bonded to the continuous pores can easily capture an object to be captured.

When the substrate is made of a polyolefin porous body having continuous pores, the reactivity of the substrate itself is low, thus, the capturing functional group of the graft polymer chain can attain selective capturing.

When the capturing material is produced, adopted is a process of including the steps of: radiating an ionizing radiation ray to a surface region of a substrate comprising a porous body having continuous pores; graft-polymerizing a polymerizable monomer having a functional group on the surface region of the substrate; and converting at least one partial quantity of the functional group to a capturing functional group. According to this producing process, graft polymerization can be effectively conducted in the surface region of the substrate to make it possible to produce easily a capturing material wherein a graft polymer chain having a capturing functional group is bonded to a surface region and the graft polymer chain is not bonded to an inner region.

The solid-phase extraction cartridge is formed by filling the capturing material into a cartridge. In this case, the capturing material may be filled thereinto in the state that the material is cut into an appropriate size, whereby the solid-phase extraction cartridge can be easily produced; therefore, in the solid-phase extraction cartridge, the capturing material is easily filled, and further an object to be captured can stably be captured. Accordingly, the cartridge is useful for removal of a metal ion contained in industrial waste water, removal of agrichemicals contained in rivers, and others.

The embodiment will be specifically described by way of the following examples; however, the invention is not limited to the examples.

### Example 1

As a sheet-form substrate, a polyethylene foamed body having continuous pores was used. A capturing material was then prepared in accordance with the steps shown in FIG. 1. In Example 1, an iminodiacetate group, which is a typical chelate-forming group, was selected as a capturing functional group to be introduced into a graft polymer chain bonded to the polyethylene foamed body. At room temperature, an electron beam was radiated to the sheet-form substrate (thickness: 2.0 mm, average pore diameter: 1 μm, and porosity: 75%) at 200 kGy in the atmosphere of nitrogen to generate radicals in surface regions of the substrate. Subsequently, the substrate irradiated with the electron beam was immersed into a 5% by volume solution of glycidyl methacrylate in methanol at 40° C. for 60 minutes to graft-polymerize glycidyl methacrylate. At this time, the grafting ratio, which is defined as the increasing ratio by mass, was 130%. The resultant substrate may be called the grafted substrate hereinafter.

At this time, the substrate was swelled into a thickness of 2.8 mm by the graft polymerization. Accordingly, the apparent linear expansion coefficient was 40% [(2.8−2.0)×100/2.0]. When the same graft polymer was bonded to the whole of the same substrate by graft polymerization, the thickness of the substrate was duplicated. The apparent linear expansion coefficient was 100%.

The graft polymer chain invaded the grafted substrate from each surface thereof by a depth of about 0.7 mm, and was bonded to the substrate. The other region, that is, the inner region (central region) corresponding to a thickness of 1.4 mm was made of the substrate itself, and was in the state that the graft polymer chain was not bonded to the region. In capturing of a copper ion by the capturing material, which will be detailed later, the surface regions, where a copper ion was captured, turned blue while the inner region, where no copper ion was captured, was kept in white color; by measuring the thicknesses of these regions, the above-mentioned thicknesses were obtained. As described herein, when the inner region of the substrate is left as it is without being grafted, the strength of the grafted substrate is kept; thus, the grafted substrate is easily fitted into a solid-phase extraction kit or a solid-phase extraction cartridge.

Subsequently, the grafted substrate was immersed into a 0.43 M sodium iminodiacetate solution at 80° C. for a predetermined time. By the generated reaction, a partial quantity of the epoxy group (species) in the graft polymer chain (species) was converted to an iminodiacetate group (species) to yield a capturing material. The conversion ratio from the epoxy group in the graft polymer chain to the iminodiacetate group was calculated out from an increase in the mass of the grafted substrate, which followed the reaction, in accordance with the following equation:

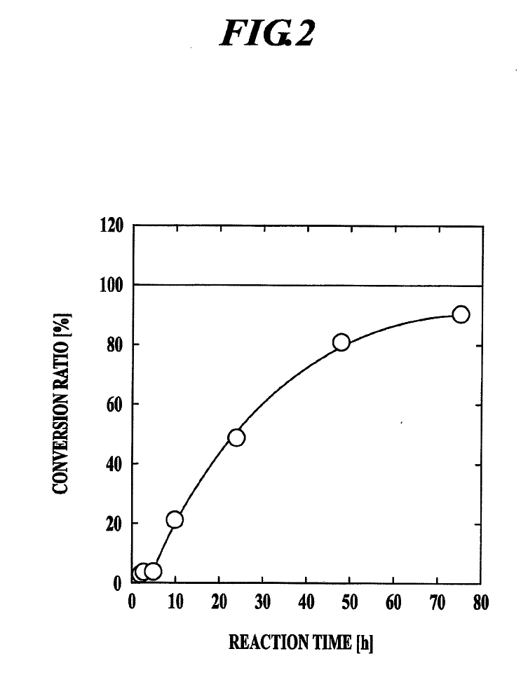

Conversion ratio (%)=100×[(W₂W₁)/176]/[W₁−W₀)/142]

wherein W₀, W₁ and W₂ represent the mass of the substrate, that of the grafted substrate and the capturing material, respectively, and the numbers 142 and 176 are the molecular weights of glycidyl methacrylate and sodium iminodiacetate, respectively. A relationship between the reaction time (h) and the conversion ratio (%) was shown in FIG. 2. As illustrated in FIG. 2, the conversion ratio became larger as the reaction time became larger. At a reaction time of 50 hours, the conversion ratio increased to 80%.

In a case where a graft polymer chain is given to the capturing material up to the center thereof and then a functional group is introduced thereinto, the dimension stability of the capturing material cannot be certainly kept when a solution containing an object to be captured is caused to flow into a solid-phase extraction kit or solid-phase extraction cartridge into which the capturing material is filled. In other words, between the time of capturing the object to be captured and the time of eluting out the object, the pH of the solution, the ion strength thereof, and others are different; therefore, the capturing material swells so that the material warps in the container or, conversely, the material shrinks so that gaps are made in the container. In such a situation, drift current is caused in the solution containing the object to be captured in the container. As a result, the solution cannot be effectively caused to flow.

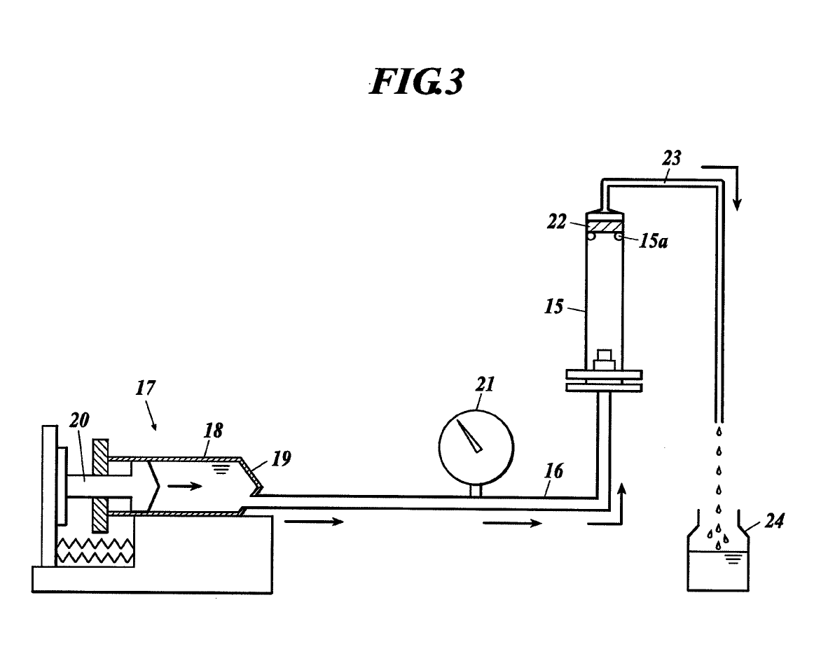

In order to increase the capturing velocity of a metal ion or protein, it is effective to cause a solution containing the metal ion or protein to permeate into a capturing material made of a porous body having continuous pores. Thus, an apparatus illustrated in FIG. 3 was used to capture a metal ion or protein. This apparatus will be described. As illustrated in FIG. 3, to the bottom of a cylindrical cartridge 15 is connected one end of a pipe 16 for supplying an object to be captured, and the other end thereof is connected to a cylinder 18 of a syringe pump 17. The cylinder 18 is filled with a feed 19 (=an aqueous solution of cupric copper chloride) as the object to be captured. By action of a piston 20, the feed 19 is supplied through the supplying pipe 16 to a cartridge 15. In the middle of the supplying pipe 16, a pressure meter 21 is set, and through the meter 21 the pressure of the feed 19 in the supplying pipe 16 is measured. In this way, the pressure in the supplying pipe 16 is adjusted not to be made too high, and further the amount of the feed 19 supplied into the cartridge 15 can be set to an appropriate value.

In the cartridge 15, the capturing material 22 is supported by a supporter 15a in the state that the material is cut into a diameter of 13 mm and a thickness of 3 mm. In the cartridge 15, from the lower portion thereof to the upper portion thereof, the feed 19 is caused to flow at a constant flow rate. One end of an outflow pipe 23 is connected to the top of the cartridge 15, and the other end is opened above a storage bottle 24. Thus, an effluent is passed through the outflow pipe 23 so as to be stored in the storage bottle 24.

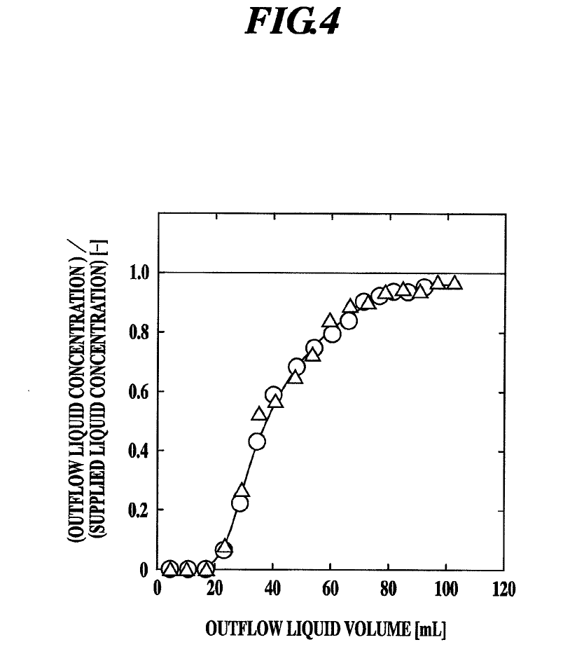

As the feed 19, there was used an aqueous solution of cupric copper chloride having a copper concentration of 200 mg/L, which was prepared by dissolving the salt into an acetic acid buffer solution (pH 4). The flow rate of the feed 19 was set to 150 and 1500 mL/h. An effluent from the outflow pipe 23 was continuously collected, and the copper ion in the effluent was quantitatively analyzed. The feed 19 was continuously caused to flow until the copper ion concentration in the effluent became equal to that in the feed. Relationships between the effluent volume and the copper ion concentration in the effluent, which were obtained from this experiment, that is, breakthrough curves were shown in FIG. 4. The horizontal axis in the graph shown in FIG. 4 represents the volume (mL) of the effluent, and the vertical axis represents the value obtained by dividing the copper ion concentration in the effluent by that in the feed. In FIG. 4, points represented by circle marks were obtained in a case where the flow rate of the aqueous solution of cupric copper chloride was 150 mL/h while points represented by triangle marks were obtained in a case where the flow rate of the aqueous solution of cupric copper chloride was 1500 mL/h. The grafting ratio is 130%, and the conversion ratio is 67%.

As illustrated in FIG. 4, obtained was a result that even if the flow rate of the aqueous solution of cupric copper chloride was changed to be made 10 times larger from 150 to 1500 mL/h, the breakthrough curves before and after the change were consistent with each other. This demonstrates that copper ions are instantaneously moved from the continuous pores in the capturing material to the chelate-forming groups introduced in the graft polymer chains, so as to be captured. This matter is advantageous for solid-phase extraction operation since an aqueous solution of cupric copper chloride can be treated at a high speed.

From the breakthrough curves in FIG. 4, the copper ion equilibrium capturing capacity of the capturing material to the copper ion concentration in the feed was calculated out. The copper ion equilibrium capturing capacity was 1.1 mol/kg. At the pH in this experiment, copper ions and iminodiacetate groups are theoretically bonded to each other at a mole ratio of 1/2. In Example 1, the amount of the captured copper ions was 1.1 mol/kg relatively to an iminodiacetate group amount of 2.0 mol/kg; therefore, it is understood that almost all of the introduced iminodiacetate groups contributed to the capturing of the copper ions. Furthermore, the copper ions captured by the capturing material were wholly eluted out by causing 2-M hydrochloric acid (HCl) to flow into the cartridge.

### Example 2

In Example 1, it has been demonstrated that a metal (copper) ion can be captured at a high speed by an iminodiacetate group, which is a chelate-forming group, as a capturing functional group introduced to a graft polymer chain bonded to a capturing material. In Example 2, it will be demonstrated that a capturing material obtained by introducing a sulfonate group, which is a cation-exchange group, as a capturing functional group, into a graft polymer chain can capture a protein at a high speed.

The grafted substrate in Example 1 was immersed into a 10% solution of sodium sulfite in water at 80° C. By the generated reaction, a partial quantity of the epoxy group (species) in the graft polymer chain was converted to a sulfonate group (species). The conversion ratio from the epoxy group in the graft polymer chain to the sulfonate group was calculated from an increase in the mass of the grafted substrate, which followed the reaction, in accordance with the following equation:

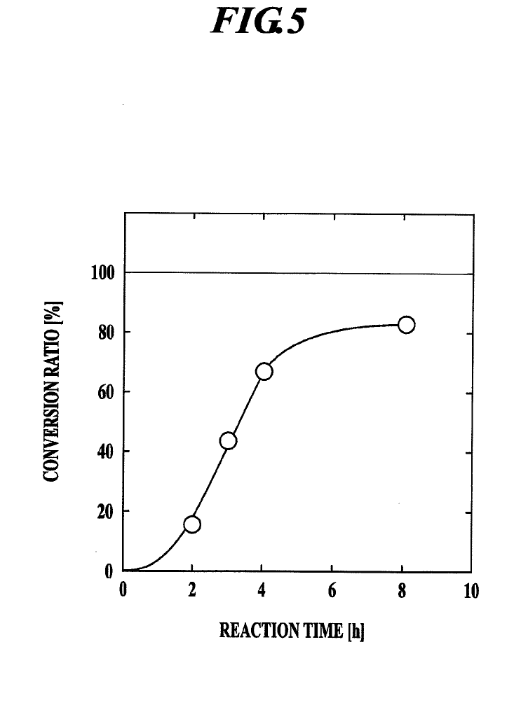

Conversion ratio (%)=100×[(W₂−W₁)/103]/[(W₁−W₀)/142]

wherein W₀, W₁ and W₂ represent the mass of the substrate, that of the grafted substrate and the capturing material, respectively, and the numbers 142 and 103 are the molecular weights of glycidyl methacrylate and sodium sulfite (NaSO₃), respectively. A relationship between the reaction time (h) and the conversion ratio (%) is shown in FIG. 5. The conversion ratio became larger as the reaction time became larger. At a reaction time of 8 hours, the conversion ratio increased to 84%.

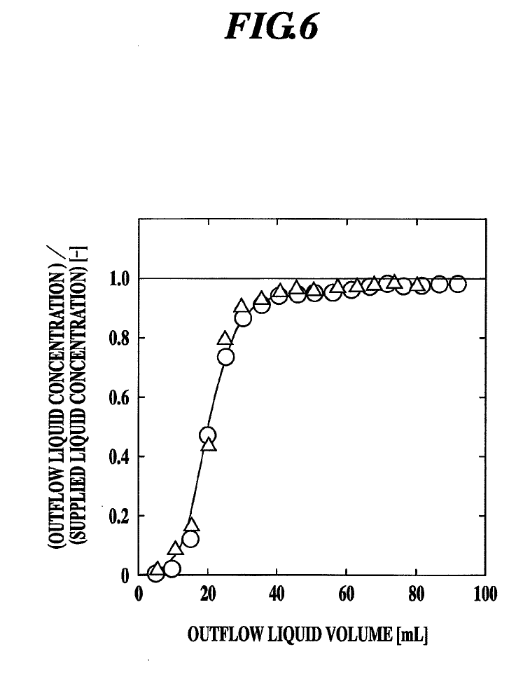

The capturing material 22 was cut into a diameter of 13 mm and a thickness of 3 mm. The cut material 22 was filled into the cartridge 15 in the apparatus illustrated in FIG. 3, and further a feed 19 (=a lysozyme (enzyme) solution) as an object to be captured was filled into the cylinder 18 of the syringe pump 17. As the feed 19, there was used a lysozyme solution having a lysozyme concentration of 0.5 g/L, which was prepared by dissolving lysozyme into a carbonic acid buffer solution (pH 9.0). The flow rate of the feed 19 was set to 150 and 1500 mL/h. Breakthrough curves obtained under the above-mentioned conditions were shown in FIG. 6. In FIG. 6, points represented by circle marks were obtained in a case where the flow rate of the lysozyme solution was 150 mL/h while points represented by triangle marks were obtained in a case where the flow rate of the lysozyme solution was 1500 mL/h. The grafting ratio is 150%, and the conversion ratio is 25%.

Even if the flow rate of the lysozyme solution was changed to be made 10 times larger from 150 to 1500 mL/h, the breakthrough curves before and after the change were consistent with each other. This demonstrates that lysozyme is instantaneously moved from the continuous pores in the capturing material to the cation-exchange groups introduced in the graft polymer chains, so as to be captured. This matter is advantageous for solid-phase extraction operation since a lysozyme solution can be treated at a high speed. Lysozyme captured by the capturing material was wholly eluted out by causing a 1-M solution of sodium chloride (NaCl) in water into the cartridge.

The present embodiment may be modified and embodied as follows:

The substrate may be made into a form other the sheet-form, such as a disc form or a rectangular plate form.

When the capturing material is used, an object to be captured may be caused to be captured by the capturing material by putting a predetermined amount of the capturing material into a container, pouring a solution of the object thereinto, and then stirring the solution.

The porous body constituting the substrate may be made of ethylene-vinyl acetate copolymer, polystyrene or the like.

Technical concepts which can be grasped through the above-mentioned embodiment are as follows:

The capturing material according to any one of claims 2 to 5, wherein the surface region of the substrate, to which the graft polymer chain is bonded, has a thickness of 40 to 60% of the thickness of the substrate. This capturing material can produce an advantageous effect that the balance between the capturing efficiency, the swelling degree and the strength can be kept at a high level as well as the advantageous effects of the capturing material according to any one of claims 2 to 5.

The capturing material according to any one of claims 1 to 5, wherein when the increasing ratio by mass based on the graft polymer chain is defined as the increasing ratio of the mass of the substrate after the graft polymerization to that of the substrate before the graft polymerization, the increasing ratio is from 100 to 2000. This capturing material can produce an advantageous effect that the grafting ratio is kept at an appropriate level and the balance between the capturing efficiency, the swelling degree and the strength can be kept at a high level as well as the advantageous effects of the capturing material according to any one of claims 1 to 5.

The capturing material according to any one of claims 3 to 5, wherein the substitution ratio from the epoxy group in the graft polymer chain to the chelate-forming group or ion-exchange group is from 5 to 90%. This capturing material can produce an advantageous effect that the ratio of the capturing functional group in the substrate is kept at an appropriate level and the capturing efficiency can be made good as well as the advantageous effects of the capturing material according to any one of claims 3 to 5.

The entire disclosure of Japanese Patent Application No. 2006-143228 filed on May 23, 2006 including description, claims, drawings, and abstract are incorporated herein by reference. Also, “High-throughput solid-phase extraction of metal ions using an iminodiacetate chelating porous disk prepared by graft polymerization” by K. Yamashiro et al., Journal of Chromatography A, 1176 (2007) 37-42 is incorporated herein by reference.

Although various exemplary embodiments have been shown and described, the invention is not limited to the embodiments shown. Therefore, the scope of the invention is intended to be limited solely by the scope of the claims that follow.

What is claimed is:

1. A producing method of a capturing material, comprising the steps of: radiating a surface region of a substrate comprising a porous body having continuous pores with ionizing radiation ray; graft-polymerizing a polymerizable monomer having a functional group onto a surface region of the substrate; and converting at least one of the functional group to a capturing functional group.
